(19) United States
(12) Patent Application Publication
(10) Pub. No.: US 2026/0094376 A1
(43) Pub. Date: Apr. 2, 2026

(54) METHODS AND APPARATUS FOR PROCESSING DATA

(71) Applicant: Arm Limited, Cambridge (GB)

(72) Inventors: Mina Ivanova DIMOVA, Great Shelford (GB); Daren CROXFORD, Swaffham Prior (GB); Roberto LOPEZ MENDEZ, Cambridge (GB)

(21) Appl. No.: 18/899,563

(22) Filed: Sep. 27, 2024

(51) Int. Cl. G06T 17/20; G06T 15/00; G06T 15/06

(52) U.S. Cl. CPC G06T 17/205; G06T 15/005; G06T 15/06

(57) ABSTRACT

According to the present techniques there is provided a method of operating a data processor unit to generate transformed geometric data, the method performed at the data processor unit comprising: receiving, first input data comprising geometric data; receiving second input data comprising shader context data associated with a graphics processing operation to be performed; and operating, at the data processor, on the geometric data using one or more machine learning models to generate transformed geometric data, wherein the machine learning model is responsive to the shader context data when generating the transformed geometric data to generate transformed geometric data adapted to support the graphics processing operation.

### TECHNICAL FIELD

The present techniques generally relate to the field of data processing and particularly, but not exclusively, to support graphics processing operations.

### BACKGROUND OF THE DISCLOSURE

Modern data processing systems may use machine learning operations to emulate dynamics of physical systems. Such machine learning operations can achieve results more efficiently compared to traditional physical based simulations.

### SUMMARY OF THE DISCLOSURE

The Applicants believe that there remains scope for using machine learning operations and the data generated thereby for supporting a graphics processing operation(s). The present technology relates to improvements in machine learning operations and how the resulting data is used.

In a first aspect there is provided a method of operating a data processor unit to generate transformed geometric data, the method performed at the data processor unit comprising: receiving, first input data comprising geometric data; receiving second input data comprising shader context data associated with a graphics processing operation to be performed; and operating, at the data processor, on the geometric data using one or more machine learning models to generate transformed geometric data, wherein the machine learning model is responsive to the shader context data when generating the transformed geometric data to generate transformed geometric data adapted to support the graphics processing operation.

In a further aspect there is provided a data processor unit to: receive first input data comprising geometric data; receive second input data comprising shader context data; and operate on the geometric data using one or more machine learning models to generate transformed geometric data, wherein the machine learning model is responsive to the shader context data when generating the transformed geometric data to generate transformed geometric data adapted to support the graphics processing operation.

In a further aspect there is provided a non-transitory computer readable storage medium comprising code which when implemented on a processor causes the processor to generate transformed geometric data by: receiving, first input data comprising geometric data; receiving second input data comprising shader context data associated with a graphics processing operation to be performed; and operating, at the data processor, on the geometric data using one or more machine learning models to generate transformed geometric data, wherein the machine learning model is responsive to the shader context data when generating the transformed geometric data to generate transformed geometric data adapted to support the graphics processing operation.

### BRIEF DESCRIPTION OF DRAWINGS

Various embodiments of the technology described herein will now be described, by way of example only and not by way of limitation, with reference to the accompanying drawings, in which:

FIG. 1 shows high-level view of an example data processor system capable of performing processing according to an implementation of the present technology;

FIG. 2A shows example data processor units of the data processor system of FIG. 1;

FIG. 2B shows example data processor units of the data processor system of FIG. 1;

FIG. 3 shows an exemplary method of generating transformed geometric data in accordance with the present techniques.

### DETAILED DESCRIPTION

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter.

The present techniques provide for supporting graphics processing operations to enable a system (e.g. a computer graphics system) to produce an output for display in a more efficient manner than would otherwise be possible.

Computer graphics systems produce their output, such as frames for display, by, in an example, processing geometric data such as so-called primitives, which are usually simple polygons such as triangles. Each primitive is normally defined by a set of vertices (e.g. three vertices in the case of triangular primitive).

Typically, the set of vertices to be used for a given graphics processing output (e.g. frame for display) will be stored as a set of vertex data defining the vertices (e.g. the relevant attributes for each of the vertices).

In the case of a typical graphics processing pipeline, the initially provided data for an output to be generated will, inter alia, comprise a set of vertices to be used and processed for generating the output, and a set (sequence) of indices referencing the set of vertices (to, in effect, define how the vertices will be used to form a set of primitives to be processed when generating the output).

Each vertex will have associated with it a set of data (such as position, colour, texture and other attributes) representing the vertex. This “geometric” or “vertex” data is then used when processing a primitive that includes the vertex in order to generate the desired output of the graphics processing system.

Once the vertices and sets of vertex indices for an output have been generated, they can be processed by an execution engine to generate the desired graphics processing output (render target), such as a frame for display.

This will comprise, inter alia, “assembling” primitives using the vertices based on the set (sequence) of vertex indices, and then processing the so-assembled primitives.

The primitive processing may involve, for example, determining which sampling points of an array of sampling points associated with the output area to be processed are covered by a primitive, and then determining the appearance each sampling point should have (e.g. in terms of its colour, etc.) to represent the primitive at that sampling point. These processes are commonly referred to as rasterising and rendering, respectively.

The rasterising and rendering processes use the vertex attributes associated with the vertices of the primitive that is being processed. To facilitate this operation at least some of the attributes of the vertices defined for the given graphics processing output are usually subjected to an initial so-called “vertex shading” (vertex processing) operation, before the primitives are, e.g. rasterised and rendered. This “vertex shading” operation operates to transform the attributes for a vertex into a desired form for the subsequent graphics processing operation(s). This may comprise, for example, transforming vertex position attributes from the model or user space that they are initially defined in, to the screen space that the output of the graphics processing is to be displayed in.

A graphics processing pipeline executed by a graphics processor (e.g. at a shader core) will typically therefore include a vertex processing stage (a vertex shader) that executes vertex processing (shading) computations on initial vertex attribute values defined for the vertices so as to generate a desired set of output vertex attributes (i.e. appropriately “shaded” attributes) for use in the subsequent processing stages of the graphics processing pipeline.

There will then be an appropriate “primitive assembly” operation that “assembles” the primitives that are to be processed by the graphics processing pipeline from the provided indices and vertices, e.g. in accordance with a defined primitive type or types that are to be assembled using the provided indices and vertices.

The so-assembled primitives will then be processed, e.g. rasterised and rendered.

In a further example computer graphics system, packets of data may be provided to the shader core, where each packet of data may have “n” primitives (e.g. 256 primitives). Each packet may then be processed by the shader core to determine the visible packets and their bounding boxes. Then each shader core may check every packet to determine if they have primitives inside a current area under consideration, for example, a tile.

In a further example computer graphics system, rather than perform vertex processing (shading) in the manner described above, a graphics processing pipeline may be configured to implement “task” and “mesh” shading stages. In contrast to the example set out above, where a vertex shader loads in a certain number of vertices and then processes (i.e. shades) the loaded vertices, a mesh shading stage can create its own output vertices and primitives.

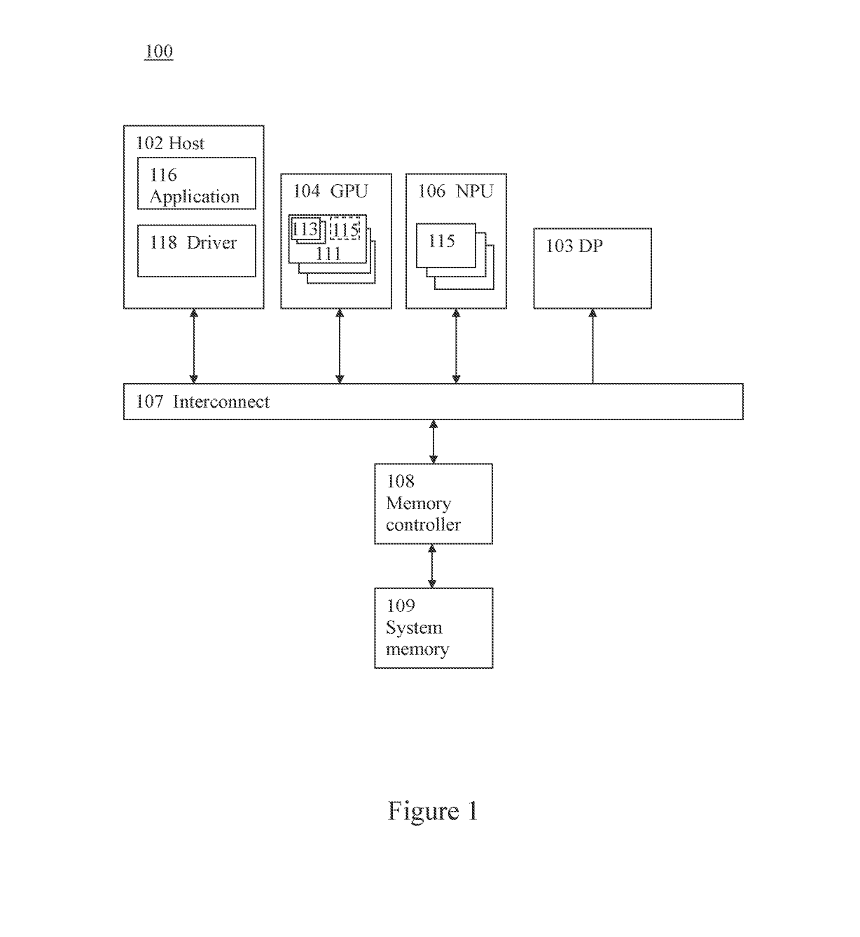

FIG. 1 shows an exemplary data processor system 100 within which the technology described herein can be implemented. As depicted in FIG. 1, the data processor system 100 in the present embodiment comprises a host processor, which may be a central processing unit (CPU) 102, a display processor 103, a graphics processor (GPU) 104, a target data processor unit which is capable of machine learning and inferencing (ML) operations and is depicted as a neural processing unit, NPU 106, and a memory controller 108. As shown in FIG. 1, these units communicate via an interconnect 107 and have access to off-chip memory 109.

In this system 100, the graphics processor 104 will, for example, render frames (images) to be displayed, and the display processor 103 will then provide the frames for output, e.g. to a display panel (not shown) for display.

The NPU 106 comprises circuits (hardware) (e.g. such as multiply-accumulate circuits) which are configured to perform ML processing operations. The NPU 106 is thus designed to perform certain types of ML operations in an optimised manner. In embodiments the NPU 106 may run an ML model (e.g. a neural network (NN)) as will be described in greater detail below.

The data processor system 100 may of course include any other components or processor units that may be desired. For instance, the data processor system 100 may further comprise an image signal processor (ISP), a video decoder, an audio codec, etc., or any other components that a data processor system 100 may desirably have.

Likewise, the data processor system 100 need not contain all of the components or processor units illustrated in FIG. 1.

GPU 104 executes a graphics processor pipeline that includes one or more processing stages (“shaders”). For example, a graphics processor pipeline being executed by GPU 104 may include one or more of, and typically all of: a geometry shader, a vertex shader and a fragment (pixel) shader and compute shader. These shaders are processing stages that execute shader programs on input data to generate a desired set of output data in accordance with one or more tasks.

In order to execute shader programs, GPU 104 includes one or more processor cores 111 (or “shader cores” or “cores”)) for that purpose.

A processor core on the GPU 104 may comprise programmable processing circuit(s) for executing the graphics programs (e.g. shader programs). GPU 104 may comprise a single shader core 111, although GPU 104 may comprise a plurality of shader cores 111 as depicted in FIG. 1.

The actual data processing operations that are performed by the shader core 111 when executing a shader program may be performed by one or more execution unit(s) 113 (hereafter “execution engine” (EE) or “graphics execution engine”) having one or more functional units (circuits), such as arithmetic units (circuits), in response to, and under the control of, the instructions in the (shader) program being executed. Thus, for example, appropriate graphics functional units will perform data processing operations in response to and as required by commands/instructions in a (shader) program being executed. (e.g. received from a host processor 102).

Each shader core 111 may comprise further components and units necessary for the execution of (shader) programs, such as, for example, local storage (e.g. one or more register files and/or L0 cache) for storing data for use by the execution engine 113 when executing a (shader) program, tile buffer, Texture Mapper (for performing texture mapping operations), RTU (Ray Tracing Unit) for perform ray tracing operations, a machine learning hardware accelerator for performing ML processing etc. It will be appreciated the shader core may have additional or alternative components or units.

NPU 106 typically comprises one or more processor unit(s) 115 to perform processing operations of a particular type or types.

In the present illustrative example, the processor unit 115 comprises one or more functional unit(s) to perform ML operations, such as to execute one or more ML models. Such ML models may comprise, for example, graph neural networks (GNN). The NPU 106 may also comprise storage (not shown in FIG. 1) to store data related to the ML operations.

In FIG. 1, the NPU 106 is depicted as a discrete processor unit separate from the GPU 104. However, in other embodiments the functionality of the NPU 106 may be integrated into the GPU 104, where, for example, the GPU 104 may comprise neural network processing capabilities. In an illustrative example, and as depicted by the dashed line in FIG. 1, each shader core 111 of the GPU 104 may have its own dedicated processor unit 115 to provide neural network processing capabilities therefor.

In the present embodiments NPU 106 is provided to support the GPU 104 during graphics processing operations. For example, the machine learning hardware accelerator (hereafter “neural engine”) may be used to perform ML operations as will be described in greater detail below.

Application 116 executes on host processor 102 and, in the present illustrative embodiments, requires graphics processing operations and/or neural network processing operations to be performed by a target processor (e.g. GPU 104 and/or NPU 106), where a software driver 118 on the host processor 102 generates a command stream(s) to cause the target processor units 104, 106 to operate in response to the command stream(s). In embodiments a software driver 118 may be provided for each target processor.

In the present illustrative example, a command stream includes one or more commands for a target processor unit(s) 104, 106 (using one or more functional units thereat) to perform one or more processing jobs. For example, the application 116 (e.g. a game or a simulation), may submit commands and data to a driver 118 for the GPU 104. The driver 118 may then generate commands and data to cause the GPU 104 to render frames for display, and to store those frames in frame buffers, e.g. in the system memory 109. The display controller 103 may then read (stream) the frames from system memory 109 into an internal buffer and may then output the data to a display panel of the display (not shown).

The present techniques provide mechanisms for performing ML operations to generate transformed geometric data responsive to context (information) about a graphics operation to support the graphics operations as will be described in greater detail below.

The ML operations may be performed at a GPU (e.g. at a compute shader or at a neural engine integrated therein). Additionally or alternatively, the ML operations may be performed at a processor unit separate from the GPU, for example at an NPU or host processor, or any other processor unit capable of performing ML operations.

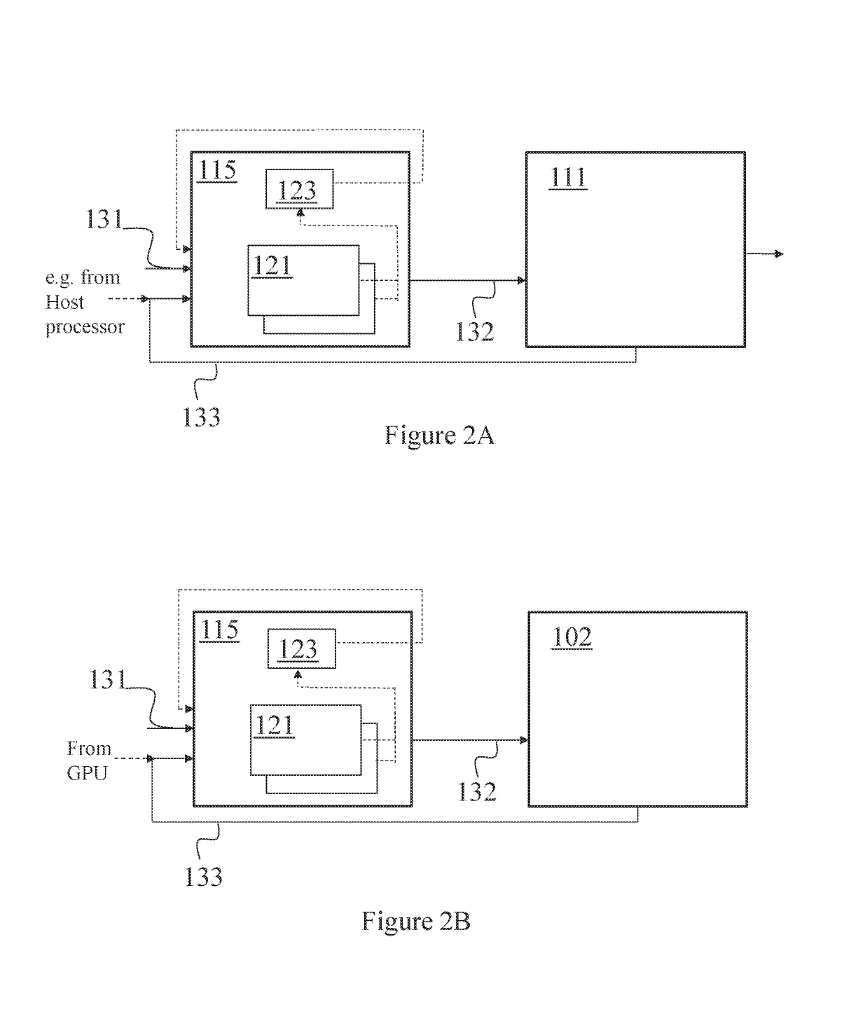

FIGS. 2A and 2B illustratively depicts a processor unit 115, which is to perform neural network processing operations to support shader operations performed at a GPU.

As depicted in FIGS. 2A and 2B, the data processor unit 115 accepts geometric data as an input 131, where the geometric data 131 is organised in a form for processing by an ML model(s). In the present illustrative examples, the geometric data is in the form of a graph or graph structured data (hereafter “graph data”), although the claims are not limited in this respect.

Graph data can be used to represent different types of information such as images, text, social networks, molecules, scenes, fabric, fluid etc, and may include attribute data to define one or more attributes of the graph data (e.g. edge attributes, vertex or node attributes, global attributes), where such attribute data may be embedded, encoded or loaded (hereafter “embedded”) into its nodes and edges, where the edges may represent the relationships/interactions between the nodes.

The processor unit 115 is to perform one or more ML operations on the graph data using one or more ML models to generate transformed graph data 132 (i.e. transformed geometric data), where the transformed graph data is to support at least one graphics processing operation at the shader core 111. (e.g. rendering by the shader core 111).

In the following embodiments the data processor unit 115 is described as an “neural engine” and is to perform ML operations in accordance with the present techniques. It will be noted that the data processor unit 115 may be execution unit capable of performing ML operations and could be part of a CPU or GPU.

The ML operations comprise running, executing or operating (hereafter “operating”) on the geometric data using one or more ML models such as a Neural Network (NN). Such a NN may be a graph NN (GNN), although the claims are not limited in this regard. Such a GNN may be a Graph Convolutional Network (GCN), Message Passing Neural Network (MPNN), Graph Attention Network (GAT), Mesh Neural Network (MNN), or Temporal Graph Network (TGN). Other types of GNN may be used and the claims are not limited to these example GNNs.

The ML model(s) for a particular operation and one or more parameters of the ML model (e.g. weights, biases, and connectivity of the network) may be fetched from storage as required for a particular ML operation. In embodiments, when the ML model is large, a portion of the ML model may be fetched at a time, for example a layer of the ML model or a sub-portion of a layer of the ML model may be fetched in order. When storage is constrained, partial results are output from memory, (for example the output of one layer), and then fetched (read back in) for processing a next layer.

A GNN may operate on graph data (nodes, edges, global context) to generate transformed geometric data. Operating the GNN on the graph data comprising geometric data (e.g. edges, vertices etc) may update the embedded attribute data to provide transformed graph data having updated attribute data (e.g. updated node, edge and/or global attributes). In an illustrative example, the edge information may be provided in the graph data or may be calculated “on the fly” by operating the GNN on the graph data. Furthermore, operating the GNN on the graph data may add geometric data to the graph data or remove geometric data from the graph data.

The neural engine 115 receives a second input 133 (e.g. from the shader core 111 or the CPU 102) which provides context or information about the graphics processing operations at a shader core performing the processing operations, and/or which provides information about the operation or configuration (e.g. hardware or software configuration) of the shader core performing the processing operations. The second input 133 is hereafter referred to as “shader context data.”

As in illustrative example, the shader context data may provide information about one or more frames to be rendered. For example, the shader context data 133 may provide information on the geometry data in a frame, the position of a viewpoint (hereafter referred to as a “camera”) in the frame (e.g. a 3D vertex); the camera view (e.g. 3D vector), the camera frustum in the frame etc.

In a further illustrative example, the shader context data may provide information about the operation of the shader core 111, such as for example the available HW resources (e.g. processing speed; storage capacity etc.) or the configuration of the shader core 111 (e.g. the shader stages available etc.)

In a further illustrative example, the shader context data may provide information, such as a performance indication, about any constraints or targets which the shader core 111 is required to meet, such as for example a frame completion time threshold or min/max vertices per frame, etc. Such constraints or targets may be set by a user (e.g. via a GUI) or an application and passed to the neural engine 115.

The shader context data may then be used by neural engine 115 to inform (e.g. configure) the ML operations when generating the transformed geometric data 132. For example, the one or more ML models used for a particular operation and/or the ML model properties or parameters (e.g. weights, biases, layers, connectivity etc.) of the one or more ML models may be configured responsive to second input data 133.

As an illustrative example, the neural engine 115 may operate on graph data using a particular GNN (dependent on the type of graph data) where the GNN model is configured responsive to second input data 133 comprising shader context data.

The resulting transformed geometric data 132 may be provided to a further processor unit, such as a shader core 111 (as depicted in FIG. 2A) which is to perform graphics processing operations or to a host processor 102 (as depicted in FIG. 2B) which is to instruct graphics processing operations at, for example, a GPU.

In an embodiment as depicted in FIG. 2A, when the transformed geometric data 132 is provided to the shader core 111, the shader core 111 may generate one or more frames based on or in response to the transformed geometric data 132, where the transformed geometric data 132 is generated responsive to the shader context data. Such transformed geometric data 132 may enable the shader core 111 to render a frame in a more efficient or optimised manner than would otherwise be achieved in the absence of the transformed geometric data 132 generated responsive to the shader context data as will be described in greater detail below.

In an embodiment as depicted in FIG. 2B, when the transformed geometric data 132 is provided to the host processor 102, the host processor 102 may provide instructions to the shader core to generate one or more frames based on or in response to the transformed geometric data 132. The transformed geometric data 132 may enable the host processor 102 to generate instructions for the shader core 111 to render a frame in a more efficient or optimised manner than would otherwise by achieved in the absence of the transformed geometric data 132 as will be described in greater detail below.

In accordance with the present techniques, the neural engine 115 may perform such ML operations to support the shader core 111 generating a graphics processing output (e.g. rendering a frame).

Such support may be provided when the shader core 111 is under one or more constraints (e.g. storage or processor constraints), or during computationally expensive applications. Such a computationally expensive application may include a physics-based simulations to model an object. In embodiments the object to be modelled may be a deformable object Such a simulation may be in one or more fields including, astrophysics, Newtonian physics, aerodynamics, fluid dynamics, climate science, soft-body physics, thermodynamics etc.

As an illustrative embodiment, a GNN may be used to predict dynamic deformation of a fabric garment (e.g. T-shirt) , where the garment can be animated (along with the body animation) or manipulated by a user on the display such that the user can rotate the garment, zoom-in or zoom-out on the garment, change material properties (e.g. elasticity, stiffness) of the garment, change of topology (zipping/unzipping) etc. The user may also change the shape of the garment (e.g. by applying an external force on the garment (e.g. throwing a virtual ball or virtual fluid (e.g. water/dirt) at the garment) to see how the garment reacts to the external force (e.g. gravity, bending, inertia, wind, acceleration, object movement, stretch, shear, friction, collision etc.).

Typically, a shader core will render each frame responsive to commands from a host processor, where the commands from the host processor may be generated responsive to inputs from a user using the simulation application. When the user, e.g. via a graphical interface on the display, changes a property (e.g. a material property) of the garment, the host processor may issue commands to the GPU to render the garment taking account of the changes instructed by the user.

As will be appreciated, generating a graphics processing output can be computationally expensive for a shader core, given the calculations that are required to be performed to effectively provide frames for display that take account of any user changes so as to provide realistic behaviour for the subject object(s) (the T-shirt in the present illustrative example).

Thus, in accordance with the present techniques and continuing the illustrative example of the garment, neural engine 115 supports the shader core 111 to generate a graphics processing output (e.g. frames) by reducing the computation burden or expense at the shader core by, for example, reducing the amount of data that the shader core 111 has to process, or reducing the number of rendering steps that the shader core 111 has to perform.

In the present illustrative example of modelling a garment, for example, by an application being executed on a computer system or by virtue of the simulation being integrated into a game being executed on the computer system. A host processor (e.g. CPU) may cause an initial image of the garment to be displayed to the user. As the initial image presented to the user may be pre-set or pre-generated to appear when the application starts, the computational expense for the shader core to generate the initial image may be relatively low. In a further illustrative example, the garment may be depicted as being worn by a character.

However, when the user interacts with the garment to change properties of the garment (e.g. via an input device, such as a mouse and/or keyboard or via a tactile input via a touchscreen) or when the character wearing the garment moves or interacts with the garment, the computational expense to calculate updated attributes of the geometric data (e.g. edges/vertices) to take account of the updated properties may increase.

Thus, in accordance with the present techniques, the host processor may provide input data comprising geometric data representative of the T-shirt to the neural engine.

In the present illustrative embodiments, the geometric data comprises graph data, but may be organised in any suitable manner for processing by a ML model(s). In some cases, the graph data may be suitable for a particular GNN that the neural engine is to use to operate on the graph data, or the neural engine may transform, using a transformer, input data to graph data suitable to be operated on using the GNN.

The neural engine may also receive shader context data which may provide context about one or more frames to be rendered by the shader core 111 and/or which may provide information about the operation of the shader core 111.

In the present illustrative example, during inference, the neural engine may operate on the graph data using a ML model, such as a GNN, to perform various ML operations. The neural engine can then generate transformed graph data 132 for use in graphics processing operations where the transformed geometric data 132 is to support the shader core 111 (e.g. to free up resources, lower the computation expense at the shader core 111 to generate one or more frames using conventional graphics processing techniques).

In an example, the neural engine may determine how the attributes of the vertices/edges of the graph data from the host application are changed responsive to the user inputs (e.g. changing material properties or generating forces to act on one or more objects in the simulation application), which may be provided to the neural engine as shader context data, and update the attributes accordingly to provide transformed graph data. The transformed graph data may be provided to the shader core for use in the graphics processing operations such that the shader core does not have to calculate the attributes. In a further illustrative example, the updated attributes may be provided to the host processor which may generate a drawing instruction for the shader core taking account of the updated attributes.

In a further example, the GNN may perform visibility checks, e.g. responsive to shader context data (which may provide information about the camera position and distance between the camera and the T-shirt) to determine which vertices/edges will be visible to the user on the user’s display. The geometric data of the graph data which is determined to not be visible in the frame to be displayed may be ignored (i.e. the attributes of non-visible vertices/edges are not updated). For example, when the T-shirt is determined to be visible, but also to have non-visible portions at the back, any effects (e.g. wrinkles, folds) on the back of the garment will not need to be rendered, and so the attributes relating to the non-visible vertices/edges need not be computed.

Thus, by ignoring some of the graph data (i.e. the graph data determined to not be visible to the user), the ML model can operate on a subset of the graph data to determine the attributes of the vertices/edges in the subset, thus saving processing time and also reducing the amount of graph data that is passed on to shader core to be processed.

Thus, the processing required to be undertaken at the neural engine is reduced when the attributes of the graph-data determined to be non-visible in a frame can be ignored.

Similarly, culling graph data (e.g. vertices/edges) from the transformed graph data provided to the shader core also reduces the amount of processing that the shader core has to perform (i.e. the shader core does not have to perform visibility checks or culling and does not have to process the graph data culled at the neural engine).

In some embodiments, the graph data which is not visible for a particular frame may be discarded. However, in other embodiments, graph data representative of an object(s) in a first (current) frame may be used to compute transformed graph data representative of the object(s) in a later frame(s). Thus, the graph data that is ignored for a particular frame can be retained (e.g. in storage) and subsequently retrieved for operations related to future frames as required (e.g. when determined to be visible).

In some embodiments, the transformed geometric data 132 may be generated so as to be in a format that it can be consumed efficiently by the shader core 111 to provide for optimised processing (e.g. load balancing/increased frame completion speed).

As an illustrative example, the ML model may be trained for a specific shader core configuration (e.g. the HW/SW of the shader core) and provide transformed geometric data 132 for more optimal rendering by that shader core configuration. In the present example the ML model may provide transformed geometric data 132 targeting a specific shader core configuration which will enable the shader core to skip some of the steps in the rendering pipeline.

The transformed geometric data 132 may also optimised for a shader core that consumes packets of primitives. Furthermore, the properties of the primitives in such packets may be formatted to be provide for more efficient processing by the shader core.

As an illustrative example, the neural engine may provide for load balancing graphics processing operations at the shader core 111 by formatting the properties of the output comprising the transformed geometric data. As an illustrative example, the maximum number of primitives in a packet may be 256 primitives. Thus, when the transformed geometric data generated at the neural engine comprises 400 primitives, one way of organising the packets may be for a first packet to comprise 256 primitives and a second packet to comprise 144 primitives. However, the packets can be generated to each comprise 200 primitives to provide for improved load balancing and faster frame completion when, for example, one segment or cluster (hereafter “segment”) of a frame comprises 200 primitives and another segment comprises 200 primitives.

Other interesting use-cases of the present techniques include simplification of meshes and providing the simplified meshes as transformed geometric data, to a shader core, for rendering the simplified version.

As a further illustrative example, smaller bounding boxes will be faster to check/reject and speed up rendering. To reduce the size of the bounding box of a packet, the packets may comprise localised geometry (e.g. where a first packet comprises primitives from a portion of a first object in a frame and where a second packet comprises a primitives from a portion of a second object of the frame). Thus, segmentation (and then potentially using each segment for different purpose and rendering) and scene generation may be used. In virtualised geometry (e.g. gaming engines) an object may be broken up into segments (primitives that are nearby and have similar surface normals) – where each segment is tuned with the appropriate amount of geometric complexity. Thus, a neural engine may operate on graph data representative of each segment at the appropriate complexity level and generate transformed geometric data (e.g. comprising a packet for each segment). Thus, the packets of primitives may comprise primitives based on locality, thereby reducing the size of the packets’ bounding box.

Thus, the shader context information will indicate whether a segment is visible or not and the ML model may not process that segment or perform reduced processing thereby reducing the complexity to generate transformed geometric data and/or reducing the amount of transformed geometric data to processed. As an illustrative example, a segment facing the camera will be processed at a high level of detail and generate a relatively large amount of transformed geometric data. A segment that is oblique to the camera will require (comparatively) lower amount transformed geometric data.

In a further example, the GNN may provide for higher quality results using dynamic or adaptive remeshing.

In embodiments, the remeshing operation is to promote mesh complexity in one or more regions to which the graphics processing operation is determined to be relatively more sensitive. As an illustrative example, , a fixed number of vertices is maintained but where the vertices may be distributed in a non-uniform manner such that an object is rendered in higher detail only where needed. Such techniques may be useful for a shader core having constrained resources (e.g. memory, processing capacity etc.).

In a simplistic illustrative example of dynamic or adaptive remeshing for an object, a flag can be represented using 4 vertices when no external forces are applied (i.e. a simple rectangle). When a virtual wind is applied to the flag (e.g. by a user applying wind in a simulation), the neural engine may, perform remeshing by operating the GNN on graph data responsive to the user inputs (provided as shader context data) to determine where additional vertices should be distributed in the flag to represent the forces of the wind on the flag and generate transformed geometric data accordingly.

The shader context data may also comprise camera position, camera view frustum etc, such that the number of vertices may be increased/decreased accordingly (e.g. increasing the number of vertices when the camera is determined to be relatively close to the object (i.e. zoomed-in) and decreasing the number of vertices when the camera is determined to be relatively far from the object. As an illustrative example when the flag is determined to be far away from the camera the flag may be represented using, for example, 4 vertices and when the flag is determined to be close to the camera the flag may be represented using 50000 vertices. The neural engine may, perform remeshing by operating on the graph data using the GNN responsive to the shader context data. Furthermore, when the normal of the surface being processed is not visible (backwards facing), that surface may be omitted from processing by the ML model. Further, when the surface normal of a primitive is oblique to the camera, it may be processed with fewer vertices/primitives than a primitive/surface that is face-on to the camera.

In an embodiment, the neural engine can take account of the performance requirements, which may be provided as a performance indication as part of the shader context data, where the remeshing operation may be to adjust the mesh complexity responsive to a performance indication from a prior iteration of the graphics processing.

In an illustrative example the neural engine may determine the computation time for the shader core to process transformed geometric data comprising a certain number of vertices and the neural engine may provide transformed geometric data with which the shader core can render a frame within a threshold computation time (E.g. as required by an application).

As will be apparent from the above, the present techniques include providing an output comprising transformed geometric data to the shader core to support graphics processing that may be performed by the shader core.

In some embodiments the neural engine may provide ancillary data, such as commands, instructions or data structures or supporting geometric data (hereafter ancillary shader data), along with the transformed geometric data to provide instructions on how the shader support perform processing operations.

As an illustrative example, a rendering process that shader cores perform during graphics processing is so-called “ray tracing,” which involves tracing the paths of rays of light from a camera through sampling positions in an image plane into a scene of a frame, and simulating the effect of the interaction between the rays and objects in the scene. An output (colour) value for sampling a position in an image is then determined based on the object(s) in the scene intersected by the ray passing through the sampling position, and the properties of the surfaces of those objects. The ray tracing calculation involves determining, for each sampling position, a set of objects within the scene which a ray passing through the sampling position intersects.

A first intersection will be with the object in the scene closest to the sampling position. A secondary ray in the form of shadow ray may be cast from the first intersection point to a light source. Depending upon the material of the surface of an object, another secondary ray in the form of reflected ray may be traced from the intersection point. If the object is, at least to some degree, transparent, then a refracted secondary ray may be considered.

The output value (such as a RGB value), is then determined taking into account the interactions of the primary, and any secondary, ray(s) cast, with objects in the scene. The same process is conducted in respect of each sampling position to be considered in the frame.

To facilitate such ray tracing processing, acceleration data structures indicative of the geometry (e.g. objects) in scenes to be rendered are used when determining the intersection data for the ray(s) associated with a sampling position in the image plane to identify a subset of the geometry which a ray may intersect.

A ray tracing acceleration data structure represents and indicates the distribution of geometry (e.g. objects) in the scene being rendered, and in particular the geometry that falls within respective (sub-)volumes in the overall volume of the scene (that is being considered). In the present embodiments, ray tracing acceleration data structures in the form of Bounding Volume Hierarchy (BVH) trees may be used. In some embodiments there may be a single acceleration data structure describing the scene. However, in a preferred embodiment there may be multiple acceleration data structures, a TLAS (Top Level Acceleration data Structure), describing the location of objects in a scene, and potentially multiple BLAS (Bottom Level Acceleration data Structures), each BLAS describes a specific object in a scene. If there are multiple instances of the same object in the scene, the TLAS may reference the same BLAS multiple times.

Other suitable ray tracing acceleration data structures may also be used, as desired. For instance, rather than using a BVH hierarchy, where the scene is subdivided by volume on a per-object basis, e.g. by drawing suitable bounding volumes around subsets of geometry, the scene could instead be subdivided on a per-volume basis, e.g. into substantially equally sized sub-volumes.

Thus, in accordance with the present techniques, rather than the host processor (e.g. CPU) or shader core generating one or more ray tracing acceleration structures and providing the one or more ray tracing acceleration structures to the shader core for processing (e.g. for interrogation of the one or more ray tracing acceleration structures by the shader core), the neural engine could, operating one or more ML models on graph data representative of a scene in a frame(s), generate a ray tracing acceleration data structure(s) for the frame(s) and provide that to the shader core as ancillary shader data for processing (e.g. interrogation) along with the transformed graph data to be processed.

The present techniques may also be used for ‘hybrid’ ray tracing, where in hybrid ray tracing a scene is rendered using rasterisation in the usual way. This rasterisation step is used to determine the initial intersect when ray tracing. The scene is then ray traced, using the results from rasterisation to determine the first intersect of the rays.

Hybrid ray tracing therefore requires, geometry used for rasterization (i.e. transformed geometric data), and geometry used for ray tracing (acceleration data structure), where for hybrid ray tracing the ML model may generate both the transformed geometric data and the acceleration data structure.

As described above, for some embodiments, when generating transformed geometric data the neural engine may cull some geometric data when it’s determined that the geometric data will not be visible on the display.

However, in raytracing, as rays are reflected, the transformed geometric data for raytracing may retain geometric data even when that geometric data is determined to not be visible because some rays may hit the back of the model.

Various other arrangements would be possible, and the technology described herein may in general be used with any suitable ray tracing acceleration data structure.

In a still further example computer graphics system, a graphics processor may implement a configurable (or reconfigurable) graphics processing pipeline, where such a configurable graphics processing pipeline may be executed by a set of programmable pipeline stages that can be configured to map to a corresponding set of different stages of a graphics processing pipeline to be executed. The configuration of the programmable pipeline stages may be performed in advance of processing pipeline execution, for example prior to issuing any work items (e.g. one or more vertices) to the graphics processing pipeline. The graphics processing pipeline, once configured, can then be executed accordingly to process work items to generate an overall pipeline output. In operation, a host processor (e.g. CPU) may require the shader core on which a graphics processing pipeline is to be executed to process work for an application running (or executing) on the host processor. The host processor may provide first input data comprising geometric data and may also provide shader context data to the neural engine, where the shader context data may provide information on, for example, the resources available (e.g. available shader stages) on the shader core. The neural engine may, on operating an ML model on the geometric data generate transformed geometric data and determine the most efficient processing pipeline configuration for the configurable shader core (e.g. the shader stages that are to be executed for the processing pipeline) to process the transformed geometric data. The neural engine may then provide the transformed geometric data along with ancillary shader data comprising one or more instructions for how the shader core should configure the graphics processing pipeline on the shader core to process the transformed geometric data.

Whilst the embodiments above generally describe a single ML model running on the neural engine to support graphics operations, the claims are not limited in this respect and, in embodiments, the neural engine may use a plurality of ML models to operate on input data as required by a particular application. Furthermore, the ML models are generally described as GNNs, but the claims are not limited in this respect and the neural engine may run any suitable ML model (e.g. a CNN, DNN etc.) to support graphics operations in accordance with the present techniques.

The present techniques can be used to support/optimise various graphics processing techniques at a shader core.

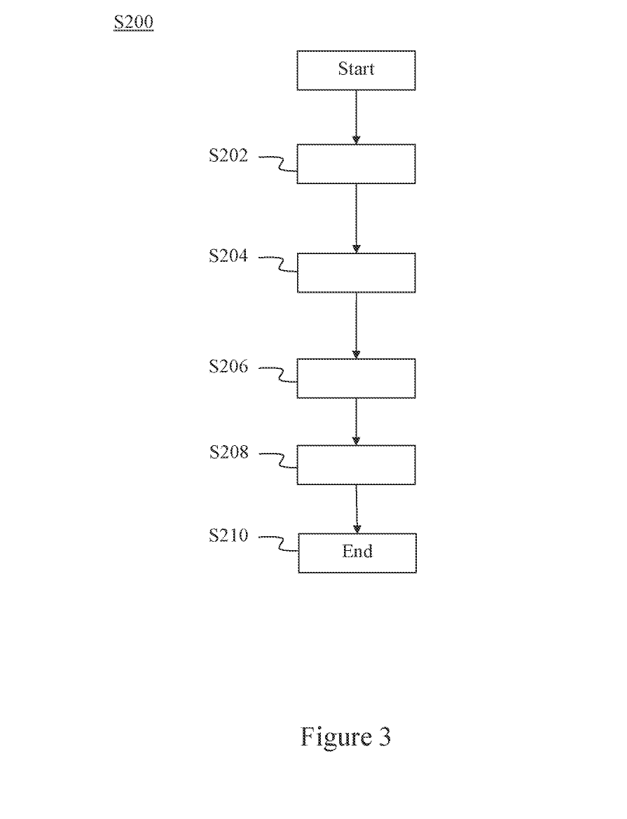

FIG. 3 illustratively shows an exemplary method 200 of operating a data processor unit to generate transformed geometric data, which is to support/optimise graphics processing operations at an execution unit in accordance with the present techniques. As described above, the data processor into unit may comprise an execution unit, such as a neural engine or any execution unit, operable to perform ML operations.

At S202 the data processor unit receives, from a host processor (e.g. a CPU), first input data comprising geometric data. The geometric data may be representative of a scene in a frame. In an illustrative example, the scene may comprise one or more objects. The geometric data may comprise, for example, vertices and primitives to represent the one or more objects, where the geometric data may comprise graph data.

At S204 the data processor unit receives second input data comprising shader context data. The shader context data may provide information, for example, about a frame to be rendered at a shader core. The shader context data may provide information on the position of a camera, or information about the camera frustum etc. In other examples the shader context data may provide information about the operation of the shader core, such as for example the available resources (e.g. processing speed; storage capacity etc.) or the configuration of the shader core.

At S206, a first execution unit (e.g. a neural engine) at the data processor unit operates on the geometric data using one or more machine learning models to generate the transformed geometric data. The machine learning model may be configured responsive to the second input data. For example, one or more parameters of the machine learning model may be set/defined/trained responsive to the second input data.

The data processor unit may also process other data to generate the transformed geometric data for a current frame. For example, in earlier processing operations for earlier frames, the data processor unit may have calculated attributes for geometric data that was determined to be not visible in the earlier frames, but which is visible for the current frames.

Thus, rather than recalculating the attributes, the data processor unit may fetch the data from storage for use in processing the transformed geometric data for the current frame.

At S208 the transformed geometric data to a shader core to support graphics processing (shading) operations.

In an illustrative example, a first data processor unit (e.g. CPU, NPU etc.) may provide the transformed geometric data to a second data processor unit to support graphics processing operations at the second data processor unit.

In a further illustrative example, the transformed geometric data may be generated (e.g. by a neural engine) at a data processor unit and then written to storage (e.g. main memory) at the data processor unit. The stored transformed geometric data may then be fetched from the storage by a shader core at the data processor unit to support graphics processing shading operations at the shader core.

At S210 the process ends.

The execution unit described above may be arranged within a dedicated neural processor unit, or may be integrated within a GPU or CPU or other processor unit etc. The data processing system may be implemented as part of any suitable electronic device which may be required to perform neural network processing, e.g., such as a desktop computer, a portable electronic device (e.g. a tablet or mobile phone), or other electronic device.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed.

The techniques further provide processor control code to implement the above-described systems and methods, for example on a general purpose computer system or on a digital signal processor (DSP). The techniques also provides a carrier carrying processor control code to, when running, implement any of the above methods, in particular on a non-transitory data carrier – such as a disk, microprocessor, CD- or DVD-ROM, programmed memory such as read-only memory (firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog^{TM}, VHDL (Very high speed integrated circuit Hardware Description Language) or SystemVerilog hardware description and hardware verification language. As the skilled person will appreciate, such code and/or data may be distributed between a plurality of coupled components in communication with one another. The techniques may comprise a controller which includes a microprocessor, working memory and program memory coupled to one or more of the components of the system.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended items.

What is claimed is:

1. A method of operating a data processor unit to generate transformed geometric data, the method performed at the data processor unit comprising:
receiving, first input data comprising geometric data;
receiving second input data comprising shader context data associated with a graphics processing operation to be performed; and
operating, at the data processor, on the geometric data using one or more machine learning models to generate transformed geometric data, wherein the machine learning model is responsive to the shader context data when generating the transformed geometric data to generate transformed geometric data adapted to support the graphics processing operation.

2. The method of claim 1, further comprising:
providing the transformed geometric data for execution by the graphics processing operation.

3. The method of claim 1, where operating on the geometric data is carried out by a machine learning hardware accelerator of the data processor.

4. The method of claim 1, further comprising performing the graphics processing operation using the transformed geometric data using graphics processing circuitry of the data processor.

5. The method of claim 4, wherein the data processor comprises a graphics processor, the graphics processor comprising the graphics processing circuitry and machine learning hardware acceleration circuitry, wherein operating on the geometric data is carried out by the machine learning hardware acceleration circuitry.

6. The method of claim 1, where the geometric data and/or the transformed geometric data comprise graph data having one or more vertices.

7. The method of claim 1, where the geometric data comprises one of: a point cloud and a mesh.

8. The method of claim 1, where a machine learning model of the one or more machine learning models comprises a graph neural network.

9. The method of claim 1, wherein operating on the geometric data using the one or more machine models to generate the transformed geometric data is to implement a physics-based simulation.

10. The method of claim 1, where the one or more machine learning models are to perform a remeshing operation on the graph data; a visibility operation on the graph data.

11. The method of claim 10, wherein the remeshing operation is to adjust the mesh complexity responsive to a performance indication from a prior iteration of the graphics processing.

12. The method of claim 1, where the visibility operation comprises:
determining which vertices of the graph data are visible on a frame to be displayed;
updating attribute data for the graph data to provide a visibility indication for at least some of the vertices;
wherein the transformed geometric data comprises the updated attribute data.

13. The method of claim 8, where the graph neural network comprises a mesh neural network.

14. The method of claim 4, where the shader context data is to provide context about a frame to be rendered and/or information about the operation or configuration of the graphics processing circuitry.

15. The method of claim 1, where the shader context data provides, for one or more frames to be rendered, one or more of: a position of the camera, a camera view, a frustum position.

16.The method of claim 1, further providing ancillary shader data comprising one or more of: a command or instruction for the shader, and a ray tracing acceleration data structure.

17. The method of claim 1, further comprising formatting the transformed geometric data to provide for load balancing during the graphics processor operations at the shader core.

18. A data processor unit to:
receive first input data comprising geometric data;
receive second input data comprising shader context data; and
operate on the geometric data using one or more machine learning models to generate transformed geometric data, wherein the machine learning model is responsive to the shader context data when generating the transformed geometric data to generate transformed geometric data adapted to support the graphics processing operation.

19. The data processor unit of claim 18, further comprising a machine learning hardware accelerator to operate on the geometric data to generate the transformed geometric data.

20. A non-transitory computer readable storage medium comprising code which when implemented on a processor causes the processor to generate transformed geometric data by:
receiving, first input data comprising geometric data;
receiving second input data comprising shader context data associated with a graphics processing operation to be performed; and
operating, at the data processor, on the geometric data using one or more machine learning models to generate transformed geometric data, wherein the machine learning model is responsive to the shader context data when generating the transformed geometric data to generate transformed geometric data adapted to support the graphics processing operation.
